(19) United States
(12) Patent Application Publication
(10) Pub. No.: US 2007/0281676 A1
(43) Pub. Date: Dec. 6, 2007

(54) MULTI MODEL ADDRESS BOOK

(75) Inventors: Jaime A. Borras, Miramar, FL (US); Iwona Turlik, Barrington, IL (US); Kenneth J. Zdunek, Schaumburg, IL (US); Stephen L. Spear, Skokie, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/421,565

(22) Filed: Jun. 1, 2006

(51) Int. Cl. H04M 3/00

(52) U.S. Cl. 455/418

(57) ABSTRACT

A wireless communication device (102) includes a multi-mode transceiver (204) that is operable to communicate with a plurality of communication networks. The device (102) also includes a memory (216) for storing: an electronic address book (226) that includes a plurality of identifiers (302), each identifier (302) identifying a call destination device; a plurality of access network choices (304) for at least one of the identifiers (302); and a plurality of service choices (308) for at least one of the identifiers. The device (102) further includes a controller (210) having access to the memory (216) for determining a preferred call model and selecting one of the plurality of access network choices and one of the plurality of service choices as a preferred call model for at least one of the identifiers.

### BACKGROUND OF THE INVENTION

1. Field of the Invention

This invention relates in general to selection of a particular call configuration and more particularly to a configurable phone book that indicates available communication networks, protocols, and services for contacting a user.

2. Description of the Related Art

As the number of users of wireless devices continues to grow, so too do the number of communication options and configurations available to connect these devices. In addition, the types and sizes of content able to be transferred between them increases as well. Examples of types of content that can be transferred are voice, video, text messages, pictures, sound recordings, and music. This content can now be transferred from one device to another via several network options, which include carrier and non-carrier networks and can be sent in conformance with any of a plurality of appropriate protocols.

Each combination of network type, service type, and protocol used to place a call can be advantageous over a different combination. Whether a combination is advantageous or disadvantageous over another combination may depend on factors such as one or both user's location, service plan, type of data being communicated, quantity of data being communicated, the time of day, quality of connection required, length of time being connected, separation between users, and many more.

For example, Wireless Local Area Networks (WLANs) can be an attractive and inexpensive alternative for typical voice services such as telephony or dispatch services and may provide additional amenities such as high-speed wireless Internet and Intranet access as well as other real-time applications that may be more specific to a given enterprise.

Wireless Wide Area Networks (wireless WANs or WANs) such as conventional cellular telephone systems are also known. Such networks provide the advantage of wide area coverage but may not be economically attractive for routine access to wideband or high speed data capabilities, such as are required for certain Internet or Intranet applications.

In addition, each network type provides a unique device identifier to each subscribing device to facilitate location of and connection to each of the wireless devices through that particular network. For instance, WAN networks typically provide 10-digit identifiers, while WLANs typically provide 4-digit identifiers. Connection of wireless devices through a WLAN typically does not implicate any expense to the users. However, if a first user connects to a second user by utilizing the second user's 10-digit WAN identifier, the second user will be connected through the WAN to the first user, even if both users are within a coverage area of a WLAN. Unlike the WLAN, connection through the WAN typically incurs a per-minute charge. Therefore, as discussed in this example, if the WLAN connection is available, connection of users through a WAN should be automatically avoided, unfortunately this has not been the case in the past. Many other network types are also known.

When a first user wishes to contact a second user, the first user can find that second user's call information by looking in an electronic phone book located on the first user's device. The phone book can contain multiple device identifiers that allow the first user's originating device to connect to the second user's destination device through any of a plurality of available networks.

However, currently, a user of an originating device must consciously consider the above-mentioned factors, such as where the originating device is currently located and where the destination device might be located, and make manual selection of a particular type of network to communicate with the selected user before placing a call. These considerations are burdensome on the originating user, waste time, create extra manual steps in placing a call, and often result in improper guessing by the originating user, necessitating a second attempt. Currently no wireless communication devices automatically determine or are preconfigured to know an optimum or desired calling configuration.

In addition, the separation of service from access for telephony and multimedia brought by IP as well as the different means of making phone calls (e.g., circuit or packet) makes knowing how to call any given user harder than before. Address books with a single call model provide only a name and a number and there is no choice of how to place the call. However, the need for the user or terminal to select which type of call to make puts new needs on the information stored for each address book entry. Current address books do not address the multiple call models possible, they assume the user identity/phone number associated with the terminal and only allow the user to select from different numbers/terminals (e.g., home office, cell, main)

Therefore a need exists to overcome the problems with the prior art as discussed above.

### SUMMARY OF THE INVENTION

Briefly, in accordance with the present invention, disclosed is a wireless communication device with a transceiver that is able to communicate with a plurality of communication networks. The device has a memory for storing destination-device identifiers associated with each of a plurality of networks, where each identifier is able to automatically initiate a communication session between the two devices (i.e., a call origination device and a call destination device) using a specific call configuration.

According to an embodiment of the present invention, a wireless communication device has an electronic address book, and the wireless communication device comprises: a processor; a user interface, communicatively coupled with the processor, for providing user output to a user of the wireless communication device; and memory, communicatively coupled with the processor, for storing the electronic address book which includes: a plurality of identifiers, each identifier identifying at least one of a call destination device and a call recipient; a plurality of access network choices for at least one of the identifiers; and a plurality of service choices for the at least one of the identifiers.

According to an embodiment of the present invention, the address book in the wireless communication device includes access network choices comprising at least one of:

2G; 3G; 4G; GSM; TDMA; EDGE; CDMA; EVDO; UMTS; HSDPA; HSUPA; iDEN; WiFi; and WiMax.

According to an embodiment of the present invention, the address book in the wireless communication device includes service choices comprising at least one of:
PTT; Video; video conversation; message or data file exchange in parallel with conversation; text messaging; pictures; sound recording; music distribution; audio conferencing; managing address books; passing information; Telephony; and Voice over IP.

An embodiment of the present invention also can include a method for selecting a call model, the method comprising: selecting a destination device identifier; sending a request to a target device corresponding to the destination device identifier selected, the request requesting information about a preferred call model; receiving the information pertaining the preferred call model; and storing at least a portion of the information in a memory as part of a preferred call model for communicating with the target device.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an illustrating of a set of wireless devices that are communicable with multiple networks in accordance with an embodiment of the present invention;

FIG. 2 is a simplified block diagram of a wireless communication device in accordance with an embodiment of the present invention;

FIG. 3 is a table illustrating a portion of the contents of a memory in accordance with an embodiment of the present invention;

FIG. 4 is a diagram illustrating a wireless device display screen showing names in a call list in accordance with an embodiment of the present invention;

FIG. 5 is a diagram illustrating a wireless device display screen showing an entry in a call list with numbers associated with multiple networks in accordance with an embodiment of the present invention;

FIG. 6 is a diagram illustrating a wireless device display screen showing an entry in a call list with a number associated with a WLAN network in accordance with an embodiment of the present invention;

FIG. 7 is a diagram illustrating a wireless device display screen showing an entry in a call list with a number associated with a WAN network in accordance with an embodiment of the present invention; and

FIG. 8 is a flow diagram illustrating the process of calling a destination wireless device with an origination wireless device in accordance with an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

The present invention relates to a method and apparatus for determining and storing in an electronic address book, a plurality of network types, destination identifiers, identities, call model types, and other settings for connecting to a single destination device. In particular, in one embodiment of the present invention, when a user selects a target and service from his address book, the originating device sends a packet data request to the target requesting information about the preferred access technology, call server, and other settings for using that service. The preferred access technology received from the target is stored as part of the address for the target and is automatically made available when placing subsequent calls to that destination device.

The present invention can be utilized for situations in which either an originating wireless device or a destination wireless device is within coverage of one or more networks, which can be carrier or non-carrier, wired or wireless, or combinations thereof. Carrier networks operate on cellular networks or Wide Area Networks (WAN) and, generally, are controlled by cellular carriers including, but not limited to, Cingulair Wireless, Sprint-Nextel, Metro PCS, Verizon Wireless, and Tmobile Wireless. Carrier networks typically employ an analog-based air interface and/or one or more digital-based air interfaces. Digital-based air interfaces utilize digital communication technologies including, but not limited to, Code Division Multiple Access (CDMA), Time Division Multiple Access (TDMA), Global System for Mobile Communications (GSM), Wideband Code Division Multiple Access (WCDMA), Code Division Multiple Access-3rd Generation (CDMA2000), and the like.

Non-carrier networks operate on wireless networks and, generally, are not controlled by cellular carriers. Non-carrier networks typically employ a wireless local area network (WLAN) based air interface including, but not limited to, IEEE 802.11 (supported by the Institute of Electrical and Electronics Engineers, Inc.) also known as Wi-Fi (supported by the Wireless Ethernet Compatibility Alliance), Bluetooth™ supported by the Bluetooth SIG, Inc., HomeRF (supported by the HomeRF Working Group Inc.), WiMAX 802.16, and the like.

The communication units or devices that operate within these networks have wireless communication capabilities, such as IEEE 802.11, Bluetooth, or Hiper-Lan and the like that preferably utilize CDMA, frequency hopping, OFDM or TDMA access technologies and one or more of various networking protocols, such as TCP/IP (Transmission Control Protocol/Internet Protocol), UDP/IP (User Datagram Protocol/IP), IPX/SPX (Inter-Packet Exchange/Sequential Packet Exchange), Net BIOS (Network Basic Input Output System) or other protocol structures.

These networks are able to be coupled to other networks, such as the Internet, through additional wired or wireless networking equipment. This coupling allows one to connect from a first network to one or more networks of the same or different types for a multi-network communication session. These networks rely on a “protocol” to communicate.

In the field of telecommunications, a communications “protocol” is the set of standard rules for data representation, signaling, authentication, and error detection required to send information over a communications channel. The communication protocols for digital network communication have many features intended to ensure reliable interchange of data over an imperfect communication channel.

As an example, imagine three servers A, B, and C, all on different networks. A and B are both coupled to radio equipment, and can communicate via the airwaves. Servers B and C are connected via a cable and exchange data over that cable.

In this example, servers A and B can communicate using a network protocol like IEEE 802.11 and B and C exchange data with the help of a protocol such as Ethernet. However, neither of these two exemplary protocols will be able to transport information from A to C, because these servers are conceptually on different networks. In this case, an inter-network protocol is utilized to “connect” them.

In some cases, two protocols are combined to form a powerful third protocol that masters both cable and wireless transmission. This technique requires a different super-protocol for each possible combination of protocols. Typically, the base protocols are left alone, and a protocol that can work on top of any of them (e.g., the Internet Protocol) is utilized. This will make two stacks of two protocols each. The inter-network protocol will communicate with each of the base protocol in their simpler language. The base protocols will not talk directly to each other.

In this system, a request on server A to send a chunk of data to C is taken by the upper protocol, which (through whatever means) knows that C is reachable through B. It therefore instructs the wireless protocol to transmit the data packet to B. On this server, the lower layer handlers will pass the packet up to the inter-network protocol, which, on recognizing that B is not the final destination, will again invoke lower-level functions. This time, the cable protocol is used to send the data to C. There the received packet is again passed to the upper protocol, which (with C being the destination) will pass it on. Often an even higher-level protocol will sit on top, and incur further processing.

Through the connectivity just described or others known now or later developed by those of ordinary skill in the art, users are able to gain full access to the Internet through wireless communication devices, such as cellular phones, PDAs, laptops, and the like. Because of this seamless connect-ability, the Internet is becoming an increasingly popular way to send voice signals.

Voice over Internet Protocol (also called VoIP, IP Telephony, Internet telephony, and Broadband Phone) is the routing of voice conversations over the Internet or any other IP-based network. The voice data flows over a general-purpose packet-switched network, instead of traditional dedicated, circuit-switched telephony transmission lines. Voice over IP traffic can be deployed on any IP network, including ones lacking a connection to the rest of the Internet, for instance on a private building-wide LAN.

### System Diagram

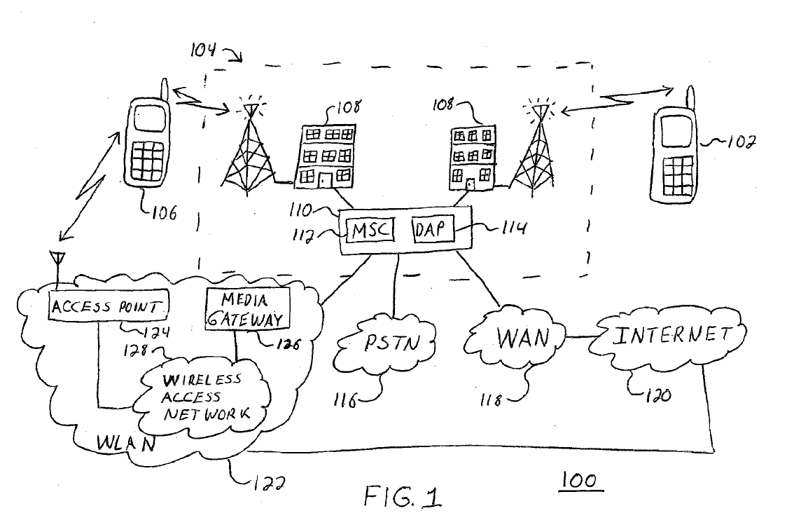

The following drawings will be helpful in understanding the present invention. Turning now to FIG. 1, a diagram of one embodiment of the present invention is shown where communication is available using either of at least four networks: a WAN, a WLAN, Public Switched Telephone Network (PSTN), and the Internet. In FIG. 1, there is shown a first wireless device, or “subscriber unit” 102 used by a first user. The first subscriber unit communicates with a communication system infrastructure 104 to link to a second subscriber unit 106. The communication system infrastructure 104 includes base stations 108 which establish service areas in the vicinity of the base station to support wireless mobile communication, as is known in the art.

The base stations 108 communicate with a central office 110 which includes call processing equipment for facilitating communication among subscriber units and between subscriber units and parties outside the communication system infrastructure, such as a mobile switching center 112 for processing mobile telephony calls, and a dispatch application processor 114 for processing dispatch or half duplex communication. Dispatch calling includes both one-to-one “private” calling and one-to-many “group” calling.

The central office 110 is further operably connected to a Public Switched Telephone Network (PSTN) 116 to connect calls between the subscriber units within the communication system infrastructure and telephone equipment outside the system 100. Furthermore, the central office 110 provides connectivity to a WLAN 122 and a WAN 118, which includes connectivity to the Internet 120.

The WLAN 122 is a non-carrier network and includes a plurality of access points 124, a media gateway 126, and a wireless access network 128, that may alternatively be referred to as Private Branch Exchange (PBX), enterprise server, media gateway controller (MGC) and so on. The wireless access network 128 allows communication between the access points 124 and the media gateway 126. The WAN 118, PSTN 116, Internet 120, and WLAN 122 communicate with each other via the central office 110. The networks shown in FIG. 1 are exemplary only and are not meant to be an exhaustive list of networks to which the present invention can be applied.

### Multiple Network Communication

As stated above, the present invention enables a subscriber unit (wireless device) 102 to operate over any of a plurality of networks without regard to the air interface technology utilized by the wireless device 102 for wireless communications. One or more of the wireless devices 102 and 106 engaged in the call are assigned a telephone number associated with each network, for example, one number for a carrier network and another number for a non-carrier network.

Referring again to FIG. 1, it can be seen that the wireless device 102 accesses the carrier network 104. Wireless device 102 can reach a second wireless device 106 via any of several options. As specifically shown in FIG. 1, the second wireless device 106 can be wirelessly linked directly via the carrier network 104 or through the WLAN 122. Therefore, a user using the originating device 102 has the option of initiating the call over either of at least these two networks. In addition, although the links are not shown, in some embodiments of the present invention, the second wireless device 106 is also accessible via the PSTN 116, the Internet 120, or any other network. These networks bring with them their own types of services, such as telephony, push-to-talk (PTT), and others.

An originating user or a destination user may have specific reasons for selecting one network over another available network for communicating. The network selected can be dependent on many factors and requirements. As an example, several advantages and disadvantages are described below for the VoIP network, which is only one of the choices available for placing a call. Each other network that is now known or later developed does have or will have specific advantages and disadvantages as well.

Regarding the Internet protocol VoIP, in general, phone service via VoIP costs less than most equivalent services from traditional sources. However, some Internet connections are asymmetrical, i.e. the upstream data rate is significantly lower than the downstream data rate. This places a final absolute throttle to the transmitted data rate and thus voice quality. This may be a factor when considering connecting to another user for the purpose of uploading or downloading large data files and engaging in sensitive conversations, where clarity is important.

VoIP to VoIP phone calls on any provider are typically free, whilst VoIP to PSTN calls generally costs the VoIP user. Again, depending on the circumstances, this may be a factor in deciding how and when to connect to a second device.

Continuing further, VoIP can facilitate tasks that may be more difficult to achieve using traditional phone networks. For instance, incoming phone calls can be automatically routed to a VoIP phone, irrespective of where a user is connected to the network. Therefore, a user can take a VoIP phone with him on a trip, and anywhere he can connect it to the Internet, he is able to receive incoming calls.

In addition, VoIP phones can integrate with other services available over the Internet, including video conversation, message or data file exchange in parallel with the conversation, audio conferencing, managing address books and passing information about whether others (e.g. friends or colleagues) are available online to interested parties.

Other advantages are that subscribers of VoIP services can make and receive local phone calls regardless of their location. For example, if a user has a New York City phone number and is traveling in Europe and someone calls the phone number, it will ring in Europe. Conversely, if a call is made from Europe to New York City, it will be treated as a local call. Of course, there must be a connection to the Internet to make all of this possible. In addition, users of Instant Messenger based VoIP services like Skype, Gizmo Project or Yahoo! Messenger can also travel anywhere in the world and make and receive phone calls.

However, VoIP technology has a few shortcomings that may lead a destination caller to request that they not be contacted over a VoIP network. Specifically, because IP does not provide any mechanism to ensure that data packets are delivered in sequential order, or provide any Quality of Service guarantees, VoIP implementations suffer problems dealing with latency (especially if satellite circuits are involved), and jitter. They are faced with the problem of restructuring streams of received IP packets, which can come in any order and have packets delayed or missing, to ensure that the ensuing audio stream maintains a proper time consistency. Another main challenge is routing VoIP traffic to traverse certain firewalls and Network Address Translation (NAT). Intermediary devices called Session Border Controllers (SBC) are often used to achieve this, though some proprietary systems such as Skype traverse firewall and NAT without a SBC by using users' computers as super node servers to route other calls. Other methods to traverse firewalls involve using protocols such as STUN or ICE.

Similar to VoIP, a WLAN and WAN has advantages and disadvantages that are to be considered when placing a call. For instance, a WLAN is advantageous as it usually incurs little or no cost to the user for accessing the network. However, security is a major concern with WLANs. One in close proximity to a building with a WLAN can pick-up and store all the wireless traffic and then crack the most common implementation of Wireless encryption (WEP) to read all the stored traffic.

In addition, data transfer speeds may not be as good as in other networks. All users of the same base station have to share the bandwidth (typically 11 Mb/s or 54 Mb/s) whilst those wired to a hub or switch typically get almost the full 100 Mb/s (assuming the hub/switch has a 100 Mb/s uplink). Also, wireless data rates degrade rapidly with signal strength/interference.

It should be clear that different networks have advantages and disadvantages that are to be taken in to account with selecting a call model for initiating a communication session with a destination device.

### Subscriber Unit

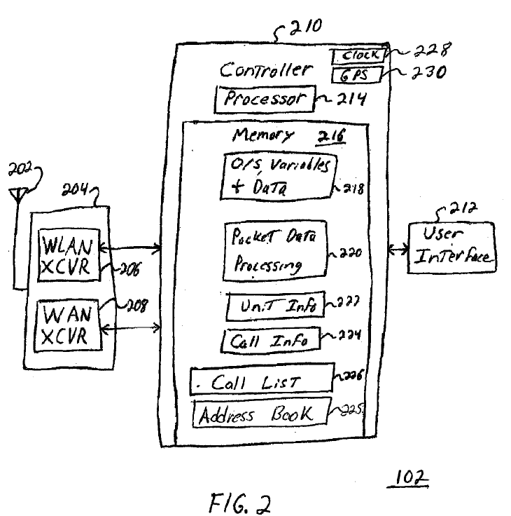

Referring now to FIG. 2, a simplified block diagram of a wireless communication unit 102, shown in FIG. 1, that is capable of facilitating ongoing communication with either of at least a first and a second wireless communication network, is shown. The communication unit 102 is generally known, thus the known functions and structure of such devices will not be described in detail other than as related to the inventive principles and concepts disclosed and discussed below. The communication unit 102 includes an antenna 202 or antenna structure that operates as both an input and an output to couple radio frequency signals between a multi-mode transceiver 204 and at least a first and second network 118, 122. For example, radio signals that are transmitted from a WAN 118 or a WLAN 122, such as respectively, by the base stations (WAN transceiver) 110 or the access points (WLAN transceiver) 124 are absorbed by the antenna 202 and coupled to a receiver that is part of the multi-mode transceiver 204.

Respectively, signals that are amplified by and coupled from the multi-mode transceiver 204, specifically a transmitter (WLAN transmitter or WAN transmitter), to the antenna 202 are radiated or transmitted or sent to the access point or base station according to known WLAN technologies, such as 802.11 and others earlier mentioned or WAN technologies, such as known cellular networks. The multi-mode transceiver 204 will be configurable to support simultaneous air interfaces with multiple communication networks according to the conventions and protocols of each or may alternatively further include one or more of a WLAN transceiver 206 and WAN transceiver 208 for such purposes as will be appreciated by those of ordinary skill. The multi-mode transceiver 204 or respective receivers and transmitters are inter coupled as depicted and interactively operate with and are controlled by a controller 210 to provide to, or accept or receive from, the controller 210, voice traffic or data messages or signals corresponding thereto such as in packet data form.

Accordingly, the multi-mode transceiver 204, as controlled by, and in cooperation with, the controller 210 and functions thereof, provide the communication unit 102 with multi or dual operating mode capability. More particularly, the communication unit 102 is capable of registering with and obtaining service from the first and second communication networks 104, 128. The controller can operate to determine whether the wireless device is within coverage or outside the coverage of a particular wireless network in many different ways, as should be obvious to those of ordinary skill in the art in view of the present discussion. For example, and without limitation, some transceivers use a received signal strength indication (RSSI) signal to indicate whether the wireless device is in coverage of a wireless network. As another example, and without limitation, a signal coding scheme such as used for CDMA type wireless communication systems can be received and decoded by a transceiver to indicate whether the wireless device is in coverage. As a third example, and without limitation, a wireless device may utilize a location detection means to detect the location of the wireless device in a geographic area. A location detection means may include use of a GPS receiver or other signal receiver that indicates location of the device within a geographic area. The location of the wireless device in a geographic area may be used to determine whether the wireless device is within coverage or outside of the coverage of a wireless network. Other equivalent forms of determination of in-network or outside-of-network coverage for the wireless device should be obvious to those of ordinary skill in the art in view of the present discussion.

The controller 210 is coupled to and generally operates in a known manner with a user interface 212. The user interface 212 is known and typically includes, for example, audio transducers, such as an earphone or speaker and microphone, a display, and a keypad. The transceiver and user interface are each inter coupled and the controller 210 provides overall operational command and control for the communication unit 102. The user interface 212 may include one or more means for providing output to a user, such as a graphics display screen, a speaker, display lights, tactile feedback devices, and others as should be obvious to those of skill in the art in view of the present discussion. The user interface 212 may also include one or more means for providing input to the device, such as keypad buttons, a microphone, a touch screen, a data port, and others as should be obvious to those of skill in the art in view of the present discussion

The controller 210, in this example, comprises a general-purpose processor and that includes a processor 214 and an associated memory 216. The processor 214 is a known processor based element with functionality that will depend on the specifics of the air interfaces with the networks in communication, as well as various network protocols for voice and data traffic. The processor 214 will operate to encode and decode voice and data messages to provide signals suitable for the transceiver, a transducer, or further processing by the controller 210. The processor 214 may include one or more generally available microprocessors, digital signal processors, and other integrated circuits depending on the responsibilities of the controller 210 with respect to signal processing duties or other unit features.

In any event, the controller 210 also includes the memory 216 that may be, for example, a combination of known RAM (Random Access Memory), ROM (Read-Only Memory), EEPROM (Electrically Erasable Programmable ROM) or magnetic memory. The memory 216 is used to store various items or programs etc., an operating system or software and data 218, such as a caller list, for execution or use by the processor 214. This operating software 218 when executed by the processor 214 will result in the processor performing the requisite functions of the communication unit 102 such as interfacing with the user interface 212 and multi-mode transceiver 204 or transmitting and receiving devices.

The memory 216 further includes call processing routines not specifically shown for supporting voice and data calls that will be appreciated by one of ordinary skill and that will vary depending on an air interface, call processing, and service provider or network specifics.

Additionally, packet data processes 220 are provided for formulating appropriate packets for transport according to the specifics of the communication networks. Furthermore various data is provided in the memory, specifically unit information 222 including identification information to identify the communication unit 102 and call information 224. Collectively this information can be used to identify a particular unit and a particular call.

A further memory location 226 is used to store device, system, or user specified information. One example of such information is a call list used to facilitate communication to other devices 106 within the network or within other networks to which the originating device 102 is not a member. This information can also be stored in other locations in memory 216 or other memories that are a part of the wireless device 102 or are external to the wireless device 102.

In addition, the device 102 has a clock 228 for determining a time of day. The clock 228 can be used in conjunction with memory 216 to provide a calendar for the device for tracking and differentiating days, months, and years. The device 102 can also be equipped with a location-determining device 230, such as a GPS.

### Address Book

In one embodiment of the present invention, the user (and the people they call) will have multiple public IDs, which includes their PSTN number for the terminal or service provider, as well as different URI or IP identities they use (e.g., enterprise, individual, family, commercial, and others). Each entry in an address book 225 in memory 216 identifies the type of preferred call model to use as well as the calling party identity to use for the individual. In one embodiment, the type of call includes circuit, and multiple VoIP call models (e.g., SIP, IMS, H.323, SKYPE, IAX, and others).

In another embodiment, the address book includes the current access network (or available service networks). A selection on how to call someone may depend on the current access (or service provider) network or the network access or service provider for the individual. For example, one may wish to call a person on the same network via that network but call them via a different identity when not on the specific network, for example call co-workers via the enterprise identity except when they are in a cellular network providing free calls to others in that network.

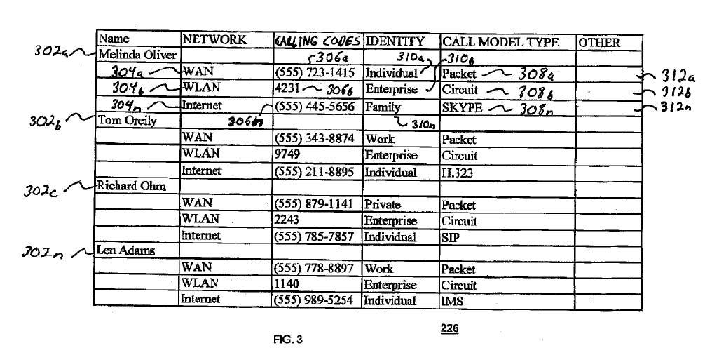

Referring now to FIG. 3, a portion of memory location 226 is shown in tabular organization. However, it is noted that the memory does not necessarily have a required organizational structural format. The memory location 226 includes a set of name fields 302a-n, which are actually identifiers that identify a destination device. Typically, the name of a user of the device is stored in this field. The name fields hold the names of possible call recipients. The names and any of the information populating the other fields that will now be described can be manually programmed into each field or automatically determined through network queries, reading computer readable media, or other known ways of determining values. Memory location 226 also has a group of network identifier fields 304a-n in each of the name fields 302a-n. The network identifiers define which networks are available to place calls to the caller identified in the name field. Each network type has a recipient device calling code with which a recipient device can be reached. The recipient calling codes are located in fields 306a-n in each name field 302a-n and corresponding to the network identifiers 304a-n. In addition, the memory location 226 also has a set of fields 308a-n that identify a call model type, which identifies the method to be used when placing the call. The call model types correspond to the network being used. For instance, if the network is the Internet, VoIP will be used and a plurality of protocols can be used. The identifier in fields 308a-n indicate which protocol should be used when placing a call to the destination user.

In an exemplary embodiment of the present invention, the network, network identifier, and call model type define a call “identity” of the destination user. These identities can be used for deciding which call configuration to use at a specific time or for grouping destination users into call groups. Looking again at FIG. 3, the memory location 226 includes a group of fields 310a-n within each name group 302a-n that stores identity indicators. The identity indicators can be any character or set of characters that allow the call configuration to be identified by a caller. Some indicators include individual, enterprise, family, work, private, X group, data, and others.

For instance, if an originating user wishes to send a private video file to a destination user, the originating user can search through the phone book to find the category “data,” which may be a VoIP line or a WAN connection, depending on the destination user's circumstances. If the call is going to be a conversation about important business matters, the highest quality connection would be desired and the originating user would then be inclined to select a category such as “work”. There are many factors to be considered when placing a call, such as per minute cost, quality of connection, maximum data rate and others. The present invention can connect to a destination user by being manually entered into a particular mode or by first contacting the other device and querying the device as to the preferred connection mode. In one embodiment of the present invention, only the preferred mode is presented to an originating user. These preferred modes can alternate depending on such factors as the originating or destination user's location, the time of day, the type of connection needed, and many others.

In one embodiment, the present invention maintains a record of the call model used to reach a destination device and the circumstances surrounding that particular call. When a subsequent call is placed to the same destination under the same circumstances, that call model is automatically selected. For instance, if a call is placed to a user at home, using SKYPE before 9:00 AM and then to that person's work number on a PSTN after 9:00 AM each weekday, the present invention will automatically present to the calling user the proper number to call, depending on the time of day and day without the calling user having to consider the best call model to use.

In the example shown in FIG. 3, the memory location 226 has an additional set of fields 312a-n, that correspond to each name field 302-n, that can hold values and can be used to store information pertaining to a remote user and/or that user's communication device. One type of information that can be stored in the additional fields 312a-n in memory location 226 is the type of service to use when placing a call. For example, telephony, push-to-talk (PTT), and others.

### Display

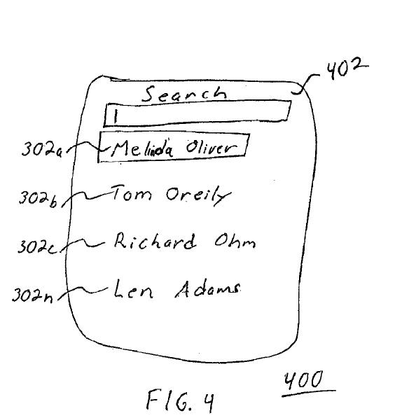

FIG. 4 is an illustration of one embodiment of a display 400, as is included in the user interface 212. The display 400 is used to allow a user of a wireless device 102 to interact with portions of the software and hardware comprising the device. One such use of the display is to select destination devices to which a communication link is desired. The devices, in this example, are generally identified by the name of their user, although this is not always the case. The display in FIG. 4 shows a search screen 402 where a list of names 302a-n is displayed. A name can be selected by typing the characters via a keypad or by scrolling down to the proper name and pressing a button to select the name or by voice recognition.

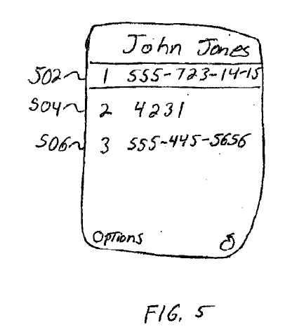

Continuing with the example, once a name is selected, the display 400 changes to a further screen, such as that shown in FIG. 5, where a list of available contact numbers is displayed. FIG. 5 shows three available numbers for John Jones. The first number 502 is a typical 10-digit WAN identifier that can be used to connect to a second user via a carrier network. The second entry 504 is a WLAN 4-digit identifier that can be used to connect to a second user through an enterprise system or others, as previously described. The third entry 506 shown in FIG. 5 is an exemplary third contact number that may include a non-cellular communication device, such as a wired telephone or the Internet.

In one embodiment of the present invention, the wireless device 102, through logic residing in memory 216 considers the network in which the originating wireless device resides at the time a call is initiated. The device 102 then makes configuration adjustments accordingly. Specifically, if the origination device is within the coverage of a WLAN, it would be highly advantageous to be connected through the WLAN to the destination device to take advantage of the increased bandwidth of the WLAN and avoid the usage costs of the WAN. Therefore, in one embodiment of the present invention, the destination user's WAN number is not displayed on the originating device's display when the call is being initiated. As a result, the originating caller will automatically be linked to the recipient through the WLAN number without any further input by the user. If the destination device is also under the coverage of the WLAN, the call will be free to the users. On the other hand, if the destination device is not under (is outside) the coverage of the WLAN, the WLAN will automatically forward the call to the destination device using the destination device's WAN number.

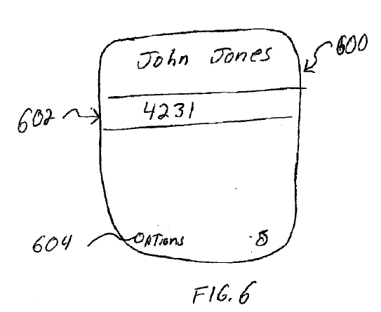

In one embodiment, once a name is selected, as shown in FIG. 4, a call is immediately initiated through the appropriate network, depending on the location of the origination device, without any further input from the initiating user. In other embodiments, a screen is shown that displays only the number associated with the network currently available to the origination device, such as shown in FIG. 6. In FIG. 6, display screen 600 displays the WLAN number 602, which is selectable by the originating user to initiate a call. This embodiment requires an additional step from the initiating user; however, other stored information can still be obtained, such as for example, through an options soft button 604 on the display 600. In this embodiment, the originating user can override the automatic number selection and initiate a call through the WAN or any other number instead.

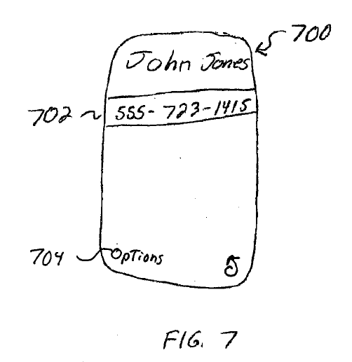

If the initiating device user is in the coverage of a WAN only, it is advantageous not to display a destination device's WLAN identification number. In this case, the device automatically hides the destination device's WLAN identifier from the call-initiating user. As in the example given above, once the destination user name is selected, the call can be immediately initiated without further user input. Alternatively, as shown in FIG. 7, the destination device's 10-digit WAN number 702 can be displayed on the screen 700. This embodiment requires an additional step from the initiating user; however, other stored information can still be obtained, such as for example, through an options soft button 704 on the display 700. During a handover stage, where the device is receiving coverage of both networks, the device can, in one embodiment of the present invention, display and make available both the WLAN identifier and the WAN identifier to a user. In another embodiment, if the origination device is receiving coverage by the WLAN, a call will always be placed through the WLAN.

In other embodiments, an electronic phone book or address book according to the present invention allows a user to select options, such as the protocol to be used, so that an optimum call model can be selected for the type of communication desired, such as data file transfer.

Each of the call models just described brings with them the call model type as indicated in memory 226 and shown in FIG. 3. Additionally, once a call is place between an origination device and a destination device, the destination device can indicate a preferred calling model other than the current model. In this case, the originating phone can initiate a call using this communicated preferred call model either during the initial non-preferred communication session, or upon disconnection from the non-preferred communication session. Additionally, the received preferred call model can be stored in memory 226 and used for future communication sessions that will conform to the stored call model.

The controller 210 of a wireless device 102, in accordance with embodiments of the present invention, functions as a selector for selecting a preferred call model based on any or all of the criteria and functionality described above. In other embodiments of the present invention, the controller 210 selects a call model based on the type, format, and amount of data to be transferred between devices.

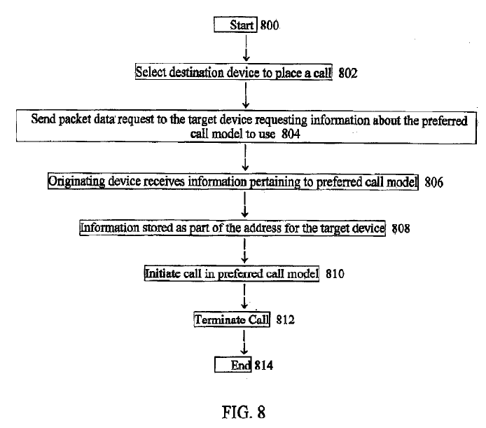

FIG. 8 shows a flow diagram illustrating an operation of the wireless device 102. The process begins at step 800 and moves directly to step 802 where a user uses an origination device and selects a destination device to place a call. The originating device then sends, in step 804, a packet data request to the target device requesting information about the preferred call model to use. This packet data request can be sent using any technique available for communicatively coupling the two devices. The preferred call model information requested should include preferences such as access technology, call server, and other settings for that service. In step 806, the originating device 102 receives back from the target device information pertaining to the preferred call model. This information is then stored, in step 808, as part of the address for the target device. A call is then initiated in the preferred call model in step 810. In step 812, the call is terminated and the flow ends at step 814.

While several embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A wireless communication device having an electronic address book, the wireless communication device comprising:
a processor;
a user interface, communicatively coupled with the processor, for providing user output to a user of the wireless communication device; and
memory, communicatively coupled with the processor, for storing an electronic address book that includes:
a plurality of identifiers, each identifier identifying at least one of a call destination device and a call recipient;
a plurality of access network choices for at least one of the identifiers; and
a plurality of service choices for the at least one of the identifiers.

2. The wireless communication device according to claim 1, wherein:
one of the plurality of access network choices and one of the plurality of service choices are presented via the user interface to a user of the wireless communication device as a representation of a preferred call model for at least one of the identifiers.

3. The wireless communication device according to claim 1, further comprising:
a timer, communicatively coupled with the processor, for altering the preferred call model that is presented to the user based on a time of day.

4. The wireless communication device according to claim 1, further comprising:
a calendar, communicatively coupled with the processor, for altering the preferred call model that is presented to the user based on a day of a week.

5. The wireless communication device according to claim 1, further comprising:
an input for receiving location information for at least one of the wireless communication device and a call destination device; and
a selector communicatively coupled with the input, the selector for selecting at least one of the plurality of access network choices and at least one of the plurality of service choices based on the location information.

6. The wireless communication device according to claim 1, further comprising:
an output for sending a request to a target device, the request requesting an identification of a service choice and an access network choice; and
an input for receiving the identification of a service choice and an access network choice.

7. The wireless communication device according to claim 1, wherein the plurality of access network choices comprises at least one of:
2G;
3G;
4G;
GSM;
TDMA;
EDGE;
CDMA;
EVDO;
UMTS;
HSDPA;
HSUPA;
iDEN;
WiFi; and
WiMax.

8. The wireless communication device according to claim 1, wherein the plurality of service choices comprises at least one of:
PTT;
Video;
video conversation;
message or data file exchange in parallel with conversation;
text messaging;
pictures;
sound recording;
music distribution;
audio conferencing;
managing address books;
passing information;
Telephony; and
Voice over IP.

9. The wireless communication device according to claim 1, further comprising:
a memory communicatively coupled to the processor for storing a record of a preferred call model used and a time the preferred call model is used;
a selector communicatively coupled with the memory for selecting a preferred call model to be used, the selection based on the record in memory.

10. The wireless communication device according to claim 1, further comprising:
a selector communicatively coupled with the memory, the selector for selecting a preferred call model to be used, the selection based on at least one of a type and a format of a packet of information to be communicated to the destination device.

11. A method for selecting a call model, the method comprising:
selecting a destination device identifier;
sending a request to a target device corresponding to the destination device identifier selected, the request requesting information about a preferred call model;
receiving the information pertaining the preferred call model; and
storing at least a portion of the information in a memory as part of a preferred call model for communicating with the target device.

12. The method according to claim 11, further comprising:
automatically initiating a call upon selection of the destination device identifier by using the at least a portion of the information.

13. The method according to claim 11, wherein the request comprises at least one of:
a preferred network type;
a preferred call model type; and
a preferred time of day.

14. The method according to claim 11, further comprising:
selecting a call model at least partially consistent with the information.

15. The method according to claim 11, further comprising:
determining a network providing communication service to an originating wireless device;
searching the memory for the at least a portion of the information pertaining the preferred call model, and selecting one of:
a call model based on the at least a portion of the information pertaining to the preferred call model if a preferred network is found in the determining step; and
an alternate call model using the network determined to be providing communication service to the originating wireless device.

16. A computer program product for selecting a call model, the computer program product comprising:
a storage medium readable by a processing circuit and storing instructions for execution by the processing circuit for performing a method comprising:
selecting a destination device identifier;
sending a request to a target device corresponding to the destination device identifier selected, the request requesting information about a preferred call model;
receiving the information pertaining the preferred call model; and
storing at least a portion of the information in a memory as part of a preferred call model for communicating with the target device.

17. The computer program product according to claim 16, further comprising:
automatically initiating a call upon selection of the destination device identifier by using the at least a portion of the information.

18. The computer program product according to claim 16, wherein the request comprises at least one of:
a preferred network type;
a preferred call model type; and
a preferred time of day.

19. The computer program product according to claim 16, further comprising:
selecting a call model at least partially consistent with the information.

20. The computer program product according to claim 16, further comprising:
determining a network providing communication service to an originating wireless device;
searching the memory for the at least a portion of the information pertaining the preferred call model, and selecting one of:
a call model based on the at least a portion of the information pertaining to the preferred call model if a preferred network is found in the determining step; and
an alternate call model using the network determined to be providing communication service to the originating wireless device.
